(19) United States
(12) Patent Application Publication
(10) Pub. No.: US 2021/0097717 A1
(43) Pub. Date: Apr. 1, 2021

(54) METHOD FOR DETECTING THREE-DIMENSIONAL HUMAN POSE INFORMATION DETECTION, ELECTRONIC DEVICE AND STORAGE MEDIUM

(71) Applicant: SHENZHEN SENSETIME TECHNOLOGY CO., LTD., Shenzhen (CN)

(72) Inventors: Luyang WANG, Shenzhen (CN); Yan CHEN, Shenzhen (CN); Sijie REN, Shenzhen (CN)

(21) Appl. No.: 17/122,222

(22) Filed: Dec. 15, 2020

Related U.S. Application Data
(63) Continuation of application No. PCT/CN2020/071945, filed on Jan. 14, 2020.

(30) Foreign Application Priority Data
Jan. 31, 2019 (CN) 201910098332.0

(51) Int. Cl. G06T 7/73; G06T 7/00; G06K 9/00

(52) U.S. Cl. CPC G06T 7/75; G06T 7/97; G06T 2207/20081; G06T 2207/30196; G06T 2207/20084; G06K 9/00369

(57) ABSTRACT

Provided are a method for detecting three-dimensional human pose information, an electronic device and a storage medium. First key points of a body of a target object in a first view image are obtained. Second key points of the body of the target object in a second view image are obtained based on the first key points. Target three-dimensional key points of the body of the target object are obtained based on the first key points and the second key points.

### CROSS-REFERENCE TO RELATED APPLICATIONS

The present application is a continuation of International Application No. PCT/CN2020/071945, filed on Jan. 14, 2020, which claims priority to Chinese Patent Application No. 201910098332.0, filed on Jan. 31, 2019. The disclosures of International Application No. PCT/CN2020/071945 and Chinese Patent Application No. 201910098332.0 are hereby incorporated by reference in their entireties.

### TECHNICAL FIELD

The disclosure relates to the field of artificial intelligence, and particularly to a method and device for detecting three-dimensional (3D) human pose information, an electronic device and a storage medium.

### BACKGROUND

3D human pose detection is a basic issue in the field of computer vision. High-accuracy 3D human pose detection is of a great application value in many fields, for example, movement recognition and analysis of a motion scenario, a human-computer interaction scenario and human movement capturing of a movie scenario. Along with the development of convolutional neural networks, related technologies for 3D human pose detection have been developed rapidly. However, in a method of predicting 3D data based on monocular two-dimensional (2D) data, depth information is uncertain, which affects the accuracy of a network model.

### SUMMARY

Embodiments of the disclosure provide a method and apparatus for detecting 3D human pose information, an electronic device and a storage medium.

To this end, the technical solutions of the embodiments of the disclosure are implemented as follows.

The embodiments of the disclosure provide a method for detecting 3D human pose information, which may include that: first key points of a body of a target object in a first view image are obtained; second key points of the body of the target object in a second view image are obtained based on the first key point; and target 3D key points of the body of the target object are obtained based on the first key points and the second key points.

The embodiments of the disclosure also provide an apparatus for detecting 3D human pose information, which may include an obtaining unit, a 2D information processing unit and a 3D information processing unit. The obtaining unit may be configured to obtain first key points of a body of a target object in a first view image. The 2D information processing unit may be configured to obtain second key points of the body of the target object in a second view image based on the first key points obtained by the obtaining unit. The 3D information processing unit may be configured to obtain target 3D key points of the body of the target object based on the first key points obtained by the obtaining unit and the second key points obtained by the 2D information processing unit.

The embodiments of the disclosure also provide a computer-readable storage medium, in which a computer program may be stored, the program being executed by a processor to implement the steps of the method of the embodiments of the disclosure.

The embodiments of the disclosure also provide an electronic device, which may include a memory, a processor and a computer program stored in the memory and capable of running in the processor, the processor executing the program to implement the steps of the method of the embodiments of the disclosure.

### BRIEF DESCRIPTION OF THE DRAWINGS

FIG. 1 is a flowchart of a method for detecting 3D human pose information according to an embodiment of the disclosure.

FIG. 2 is another flowchart of a method for detecting 3D human pose information according to an embodiment of the disclosure.

FIG. 3A and FIG. 3B are data processing flowcharts of a method for detecting 3D human pose information according to an embodiment of the disclosure.

FIG. 4 is a schematic diagram of a regulation principle of a regulation module in a method for detecting 3D human pose information according to an embodiment of the disclosure.

FIG. 5 is a structure diagram of an apparatus for detecting 3D human pose information according to an embodiment of the disclosure.

FIG. 6 is another structure diagram of an apparatus for detecting 3D human pose information according to an embodiment of the disclosure.

FIG. 7 is another structure diagram of an apparatus for detecting 3D human pose information according to an embodiment of the disclosure.

FIG. 8 is a hardware structure diagram of an electronic device according to an embodiment of the disclosure.

### DETAILED DESCRIPTION

The disclosure will further be described below in combination with the drawings and specific embodiments in detail.

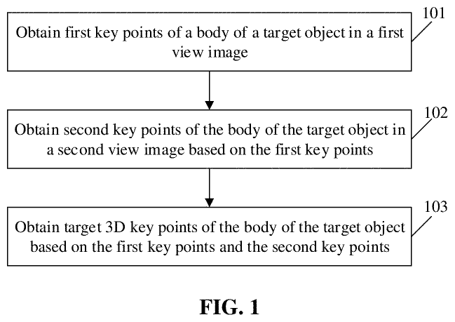

The embodiments of the disclosure provide a method for detecting 3D human pose information. FIG. 1 is a flowchart of a method for detecting 3D human pose information according to an embodiment of the disclosure. As shown in FIG. 1, the method includes the following steps.

In 101, first key points of a body of a target object in a first view image are obtained.

In 102, second key points of the body of the target object in a second view image are obtained based on the first key point.

In 103, target 3D key points of the body of the target object are obtained based on the first key points and the second key points.

In the embodiment, the first view image corresponds to an image obtained when there is a first relative position relationship (or called a first viewing angle) between an image acquisition device and the target object. Correspondingly, the second view image corresponds to an image obtained when there is a second relative position relationship (or called a second viewing angle) between the image acquisition device and the target object.

In some embodiments, the first view image may be understood as a left-eye view image, and the second view image may be understood as a right-eye view image. Alternatively, the first view image may be understood as the right-eye view image, and the second view image may be understood as the left-eye view image.

In some embodiments, the first view image and the second view image may correspond to images acquired by two cameras in a binocular camera respectively, or correspond to images collected by two image acquisition devices arranged around the target object respectively.

In the embodiment, the key points (including the first key points and the second key point) are key points corresponding to the body of the target object. The key points of the body of the target object include bone key points of the target object, for example, a joint. Of course, other key points capable of calibrating the body of the target object may also be taken as the key points in the embodiment. Exemplarily, the key points of the target object may also include edge key points of the target object.

In some embodiments, the operation of obtaining the first key points of the body of the target object in the first view image includes: obtaining the first key points of the body of the target object through a game engine, the game engine being an engine capable of obtaining 2D human key points. In the implementation, the game engine may simulate various poses of the human body to obtain 2D human key points of the human body in various poses. It can be understood that the game engine supports formation of most poses in the real world to obtain key points of a human body in various poses. It can be understood that massive key points corresponding to each pose may be obtained through the game engine, and a dataset formed by these key points may greatly improve the generalization ability of a network model trained through the dataset, to adapt the network model to real scenarios and real movements.

In some embodiments, the operation of obtaining the first key points of the body of the target object in the first view image includes: inputting the first view image to a key point extraction network, to obtain the first key points of the target object in the first view image. It can be understood that, in the embodiment, an image dataset including most of poses in the real world may also be created, and the image dataset is input to the pre-trained key points extraction network to obtain the first key points of the body of the target object in each of the various first view images.

In some optional embodiments of the disclosure, the operation that obtaining the second key points of the body of the target object in the second view image based on the first key points includes: obtaining the second key points of the body of the target object in the second view image based on the first key points and a pre-trained first network model.

In the embodiment, the first key points are input to the first network model to obtain the second key points corresponding to the second view image. Exemplarily, the first network model may be a fully-connected network structure model.

In some optional embodiments of the disclosure, the operation of obtaining the target 3D key points based on the first key points and the second key points includes: obtaining the target 3D key points based on the first key points, the second key points and a trained second network model.

In the embodiment, the first key points and the second key points are input to the second network model to obtain the target 3D key points of the body of the target object. Exemplarily, the second network model may be a fully-connected network structure model.

In some optional embodiments of the disclosure, the first network model and the second network model have the same network structure. The difference between the first network model and the second network model is that the first network model is configured to output coordinate information of 2D key points corresponding to the second view image, and the second network model is configured to output coordinate information of 3D key points.

With adoption of the technical solutions of the embodiments of the disclosure, 2D key points of one view (or viewing angle) are obtained through 2D key points of another view (or viewing angle), and target 3D key points are obtained through the 2D key points of the two views (or viewing angles), so that the uncertainty of depth prediction is eliminated to a certain extent, the accuracy of the 3D key points is improved, and the accuracy of a network model is also improved.

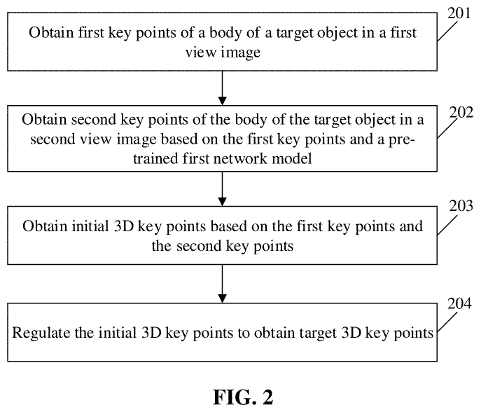

The embodiments of the disclosure also provide a method for detecting 3D human pose information. FIG. 2 is another flowchart of a method for detecting 3D human pose information according to an embodiment of the disclosure. As shown in FIG. 2, the method includes the following steps.

In 201, first key points of a body of a target object in a first view image are obtained.

In 202, second key points of the body of the target object in a second view image are obtained based on the first key points and a pre-trained first network model.

In 203, initial 3D key points are obtained based on the first key points and the second key points.

In 204, the initial 3D key points are regulated to obtain target 3D key points.

In the embodiment, specific implementations of steps 201 to 202 may refer to the related descriptions about steps 101 to 102, and elaborations are omitted herein to save the space.

In the embodiment, the operation in step 203 of obtaining the initial 3D key points based on the first key points and the second key points includes: obtaining the initial 3D key points based on the first key points, the second key points and a pre-trained second network model.

In the embodiment, it can be understood that 3D key points (i.e., the initial 3D key points) output by the second network model are not the final accurate target 3D key points, instead, the initial 3D key points are rough 3D key points, and the initial 3D key points are further regulated to obtain the high-accuracy target 3D key points.

It can be understood that the network model in the embodiment includes the first network model, the second network model and a regulation module. The first key points is input to the first network model to obtain the second key points corresponding to the second view image, the first key points and the second key points are input to the second network model to obtain the initial 3D key points, and the initial 3D key points are regulated through the regulation module to obtain the target 3D key points.

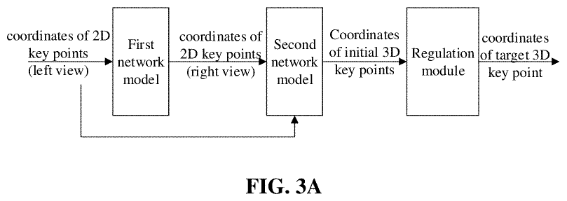

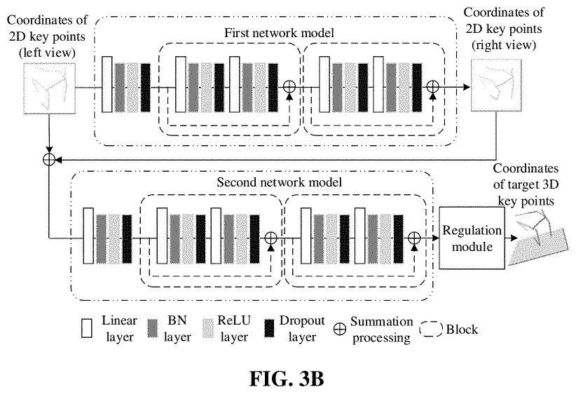

FIG. 3A and FIG. 3B are data processing flowcharts of a method for detecting 3D human pose information according to an embodiment of the disclosure. As shown in FIG. 3A, taking the input first key points being coordinates of 2D key points of a left view as an example, the input first key points is processed through the first network model to obtain coordinates of 2D key points of a right view, coordinates of the 2D key points of the left view and coordinates of the 2D key points of the right view are input to the second network model to obtain coordinates of the initial 3D key points, and the coordinates of the initial 3D key points are input to the regulation module to obtain coordinates of the target 3D key points. The left view and the right view may be understood as a left-eye view and a right-eye view.

Specifically, as shown in FIG. 3B, the first network model and the second network model may have the same network structure. Taking the first network model as an example, the first network model may include an input layer, hidden layers and an output layer. Each layer may be implemented through a function, and the layers are connected in a cascading manner. For example, the first network model may include linear layers, Batch Normalization (BN) layers, Rectified Linear Unit (ReLU) layers and dropout layers. The first network model may include multiple block structures (as shown in the figure, the first network model includes two block structures, but the embodiment is not limited to the two block structures), and each block structure includes at least one group of linear layer, BN layer, ReLU layer and dropout layer (as shown in the figure, each block structure includes two sets of linear layers, BN layers, ReLU layers and dropout layers, but the embodiment is not limited to two sets). Input data of one block structure may be output data of a previous module, or may be a sum of the output data of the previous module and output data of a module before the previous module. For example, as shown in the figure, data output by a first dropout layer may be used as input data of a first block structure, or may be used, together with output data of the first block structure, as input data of a second block structure.

In some optional embodiments of the disclosure, a training process of the first network model includes that: 2D key points of a second view are obtained based on sample 2D key points of a first view and a neural network; and a network parameter(s) of the neural network is(are) regulated based on labeled 2D key points and the 2D key points, to obtain the first network model. A training process of the second network model includes that: 3D key points are obtained based on first sample 2D key points of the first view, second sample 2D key points of the second view and a neural network; and a network parameter(s) of the neural network is(are) regulated based on labeled 3D key points and the 3D key points, to obtain the second network model. The first network model and the second network model have the same network structure, specifically as shown in FIG. 3B. The difference between the first network model and the second network model is that the first network model is configured to output 2D key points corresponding to the second view image and the second network model is configured to output 3D key points.

In the embodiment, 2D-3D data pairs formed by multiple sample 2D key points and sample 3D key points may be obtained through a game engine, the game engine being an engine capable of obtaining 2D human key points and/or 3D human key points. In the implementation, the game engine may simulate various poses of a human body, to obtain 2D human key points and/or 3D human key points of the human body in various poses. It can be understood that the game engine supports formation of most poses in the real world to obtain 2D key points and 3D key points corresponding to a human body in various poses, and may also construct 2D key points of different views (for example, including the first view and the second view) in each pose, and the constructed 2D key points may be used as sample data for training the first network model. For example, constructed 2D key points in the first view may be used as sample data for training the first network model, and constructed 2D key points in the second view may be used as labeled data for training the first network model. For example, the constructed 2D key points may also be used as sample data for training the second network model. For example, the constructed 2D key points in the first view and the second view may be used as sample data for training train the second network model, and constructed 3D key points in the first view may be used as labeled data for training the second network model. In the embodiment, the sample data may include most of poses in the real world, may adapt the network model to real scenarios and real movements. Compared with existing sample data, which are limited and are mostly based on a laboratory scenario, the sample data in the embodiment have the advantages that figures and movements are greatly enriched, adaptability to a complicated real scenario can be achieved, the generalization ability of the network model trained through the dataset is greatly improved and interference of an image background can be eliminated.

Exemplarily, the network structure of the first network model shown in FIG. 3B is taken as an example. The 2D key points in the first view are input to the network structure of the first network model shown in FIG. 3B as input data, and the data are processed through a block structure including two groups of linear layers, BN layers, ReLU layers and dropout layers, to obtain 2D key points in the second view. A loss function is determined based on coordinates of the 2D key points and coordinates of labeled 2D key points, and a network parameter(s) of the block structure including the two sets of linear layers, BN layers, ReLU layers and dropout layers is(are) regulated based on the loss function, to obtain the first network model. A training manner for the second network model is similar to the training manner for the first network model and will not be elaborated herein.

In some optional embodiments of the disclosure, the operation of regulating the initial 3D key points to obtain the target 3D key points includes: determining a 3D projection range based on the first key points and a preset camera calibration parameter(s); and for each the initial 3D key points, a 3D key point of which a distance with the initial 3D key point meets a preset condition in the 3D projection range is obtained, and the 3D key point is taken as one of the target 3D key points. The 3D projection range is a 3D range having a projection relationship with the first key points; and each of the 3D key points in the 3D projection range, after being projected to a plane where the first key points are located through the preset camera calibration parameter(s), overlaps one of the first key points on the plane where the first key points are located.

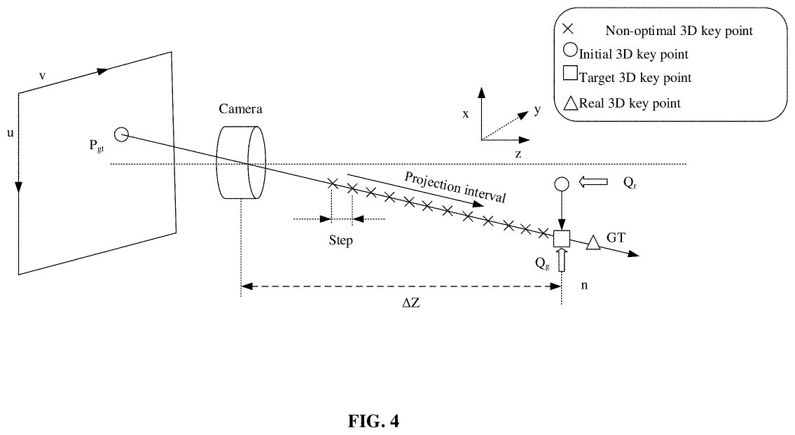

FIG. 4 is a schematic diagram of a regulation principle of a regulation module in the method for detecting 3D human pose information according to an embodiment of the disclosure. As shown in FIG. 4, there is made such a hypothesis that all 2D images are from the same image acquisition device, namely all 2D key points (including first key points and second key points in the embodiment) correspond to the same image acquisition device, and all the 2D key points correspond to the same preset camera calibration parameter(s). Based on this hypothesis, the following solution is proposed. When first key points are obtained, if real 3D key points corresponding to the first key points are obtained, for example, one of the obtained real 3D key points is the point GT in FIG. 4, the point GT, after being projected to a plane where the first key points are located through the preset camera calibration parameter(s), overlaps one of first key points (point P_{gt} in FIG. 4) on the plane where the first key points are located. Based on this principle, as shown in FIG. 4, a 3D projection range is determined based on the first key points and the preset camera calibration parameter(s), the 3D projection range being a 3D range having a projection relationship with the first key points, for example, the slash shown in FIG. 4, the slash representing a 3D projection range. For example, a 3D coordinate system is established by taking a center point of a camera as a coordinate origin, taking a plane where the camera is located as an xy plane and taking a direction perpendicular to the camera and far away from the camera as a z-axis direction, and in this case, the 3D projection range may be a 3D range represented by 3D coordinates in the 3D coordinate system. It can be understood that each of the 3D key points (including points x, point Q_{g} and point GT in FIG. 4) in the 3D projection range, after being projected to the plane where the first key points are located through the preset camera calibration parameter(s), overlaps the first key point P_{gt}. Generally, there is a certain difference between the initial 3D key points obtained through the second network model and the real 3D key points, namely the initial 3D key points are not entirely accurate. It can be understood that the initial 3D key points are very likely to be not in the 3D projection range. Taking an initial 3D key point being the point Qᵣ as an example, a 3D key point of which a distance with the 3D key point, i.e., the point Qᵣ, meets the preset condition is obtained based on a coordinate range corresponding to the 3D projection range. As shown in FIG. 4, the obtained 3D key point meeting the preset condition is the key point Q_{g}, and coordinates of the key point Q_{g} is taken as a target 3D key point.

In some optional embodiments of the disclosure, the operation of obtaining the 3D key points of which the distances with the initial 3D key points meet the preset condition in the 3D projection range includes that: for each of the initial 3D key points, multiple 3D key points in the 3D projection range are obtained according to a preset step; and an Euclidean distance between each of the 3D key points and the initial 3D key point is calculated, and a 3D key point corresponding to a minimum Euclidean distance is determined as one of the target 3D key points.

Specifically, as shown in FIG. 4, the coordinate range of the 3D projection range is determined, and multiple 3D key points are obtained according to the preset step from a minimum value of depth information (i.e., z-axis information in the figure) represented in the coordinate range, the obtained multiple 3D key points corresponding to the points x in FIG. 4. For example, if the minimum value of the depth information represented in the coordinate range is 0, superimposition is sequentially performed from z=0 according to z=z+1, to obtain the multiple points x in the figure. Then, an Euclidean distance between each point x and an initial 3D key point (i.e., the point Qᵣ in FIG. 4) is calculated, and a 3D key point corresponding to the minimum Euclidean distance is selected as a target 3D key point. The key points Q_{g} in the figure is determined as a target 3D key point.

With adoption of the technical solution of the embodiment of the disclosure, 2D key points of one view (or viewing angle) are obtained through 2D key points of the other view (or viewing angle), and target 3D key points are obtained through the 2D key points of the two views (or viewing angles), so that the uncertainty of depth prediction is eliminated to a certain extent, the accuracy of the 3D key points is improved, and the accuracy of a network model is also improved. Moreover, coordinates of the initial 3D key points output by the second network model may be regulated through the regulation module based on the principle that 3D key points may be projected back to coordinates of initial first key points, so that the accuracy of the predicted 3D key points is greatly improved.

According to the technical solution of the embodiment of the disclosure, 2D key points may be input to output accurate 3D key points, and the technical solution may be applied to intelligent video analysis and construction of a 3D human model for a human body in a video image for some intelligent operations such as simulation, analysis and movement information statistics over the human body through the detected 3D model, and is applied to a video monitoring scenario for dangerous movement recognition and analysis.

According to the technical solution of the embodiment of the disclosure, 2D key points may be input to output accurate 3D key points, the technical solution may be applied to an augmented virtual reality scenario, a human body in a virtual 3D scenario may be modeled, control and interaction of the human body in the virtual scenario may be implemented by use of detected feature points (for example, 3D key points) in the model, and scenarios of suit changing, including virtual human movement interaction and the like in a shopping application.

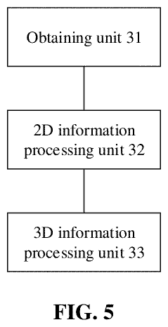

The embodiments of the disclosure also provide a device for detecting 3D human pose information. FIG. 5 is a structure diagram of a device for detecting 3D human pose information according to an embodiment of the disclosure. As shown in FIG. 5, the device includes an obtaining unit 31, a 2D information processing unit 32 and a 3D information processing unit 33. The obtaining unit 31 is configured to obtain first key points of a body of a target object in a first view image.

The 2D information processing unit 32 is configured to obtain second key points of the body of the target object in a second view image based on the first key points obtained by the obtaining unit 31.

The 3D information processing unit 33 is configured to obtain target 3D key points of the body of the target object based on the first key points obtained by the obtaining unit 31 and the second key points obtained by the 2D information processing unit 32.

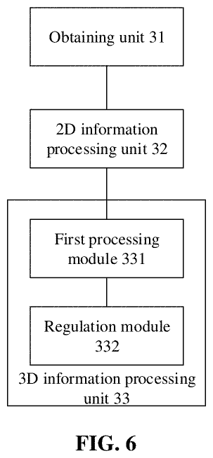

In some optional embodiments of the disclosure, as shown in FIG. 6, the 3D information processing unit 33 includes a first processing module 331 and a regulation module 332. The first processing module 331 is configured to obtain initial 3D key points based on the first key points and the second key points.

The regulation module 332 is configured to regulate the initial 3D key points obtained by the first processing module 331 to obtain the target 3D key points.

In some optional embodiments of the disclosure, the regulation module 332 is configured to determine a 3D projection range based on the first key points and a preset camera calibration parameter(s), for each of the initial 3D key points, obtain a 3D key point of which a distance with the initial 3D key point meets a preset condition in the 3D projection range and take the 3D key point as one of the target 3D key points.

The 3D projection range is a 3D range having a projection relationship with the first key points; and each of the 3D key points in the 3D projection range, after being projected to a plane where the first key points are located through the preset camera calibration parameter(s), overlaps one of the first key points on the plane where the first key points are located.

In some optional embodiments of the disclosure, the regulation module 332 is configured to, for each of the initial 3D key points, obtain multiple 3D key points in the 3D projection range according to a preset step; calculate an Euclidean distance between each of the 3D key points and the initial 3D key point and determine a 3D key point corresponding to a minimum Euclidean distance as one of the target 3D key points.

In some optional embodiments of the disclosure, the 2D information processing unit 32 is configured to obtain the second key points of the body of the target object in the second view image based on the first key points and a pre-trained first network model.

The first processing module 331 is configured to obtain the initial 3D key points based on the first key points, the second key points and a pre-trained second network model.

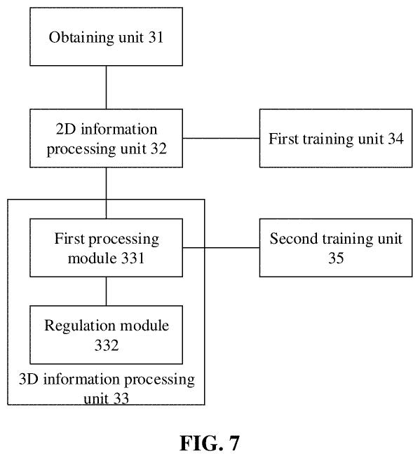

In some optional embodiments of the disclosure, as shown in FIG. 7, the device further include a first training unit 34, configured to obtain 2D key points of a second view based on sample 2D key points of a first view and a neural network, and regulate a network parameter(s) of the neural network based on labeled 2D key points and the 2D key points to obtain the first network model.

In some optional embodiments of the disclosure, the device further includes a second training unit 35, configured to obtain 3D key points based on first sample 2D key points of the first view, second sample 2D key points of the second view and a neural network, and regulate a network parameter(s) of the neural network based on labeled 3D key points and the 3D key points to obtain the second network model.

In the embodiment of the disclosure, all the obtaining unit 31, 2D information processing unit 32, 3D information processing unit 33 (including the first processing module 331 and the regulation module 332), first training unit 34 and second training unit 35 in the device for detecting 3D human pose information may be implemented by a Central Processing Unit (CPU), a Digital Signal Processor (DSP), Microcontroller Unit (MCU) or Field-Programmable Gate Array (FPGA) during a practical application.

It is to be noted that the device for detecting 3D human pose information provided in the embodiment is described with division of each of the abovementioned program modules as an example during 3D human pose information detection. In practical application, such processing may be allocated to different program modules for completion according to a requirement, that is, an internal structure of the device is divided into different program modules to complete all or part of abovementioned processing. In addition, the device for detecting 3D human pose information provided in the embodiment belongs to the same concept of the method for detecting 3D human pose information embodiment and details about a specific implementation process thereof refer to the method embodiment and will not be elaborated herein.

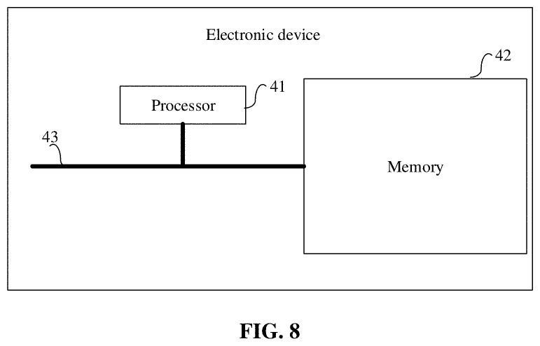

The embodiments of the disclosure also provide an electronic device. FIG. 8 is a hardware composition structure diagram of an electronic device according to an embodiment of the disclosure. As shown in FIG. 8, the electronic device includes a memory 42, a processor 41 and a computer program stored in the memory 42 and capable of running in the processor 41, the processor 41 executing the program to implement the steps of the method of the embodiments of the disclosure.

It can be understood that each component in the electronic device is coupled together through a bus system 43. It can be understood that the bus system 43 is configured to implement connection communication between these components. The bus system 43 includes a data bus and further includes a power bus, a control bus and a state signal bus. However, for clear description, various buses in FIG. 8 are marked as the bus system 43.

It can be understood that the memory 42 may be a volatile memory or a nonvolatile memory, and may also include both of the volatile and nonvolatile memories.

The nonvolatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, a compact disc or a Compact Disc Read-Only Memory (CD-ROM). The magnetic surface memory may be a disk memory or a tape memory. The volatile memory may be a Random Access Memory (RAM), and is used as an external high-speed cache. It is exemplarily but unlimitedly described that RAMs in various forms may be adopted, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM) and a Direct Rambus Random Access Memory (DRRAM). The memory 702 described in the embodiment of the disclosure is intended to include, but not limited to, memories of these and any other proper types.

The method disclosed in the embodiment of the disclosure may be applied to the processor 41 or implemented by the processor 41. The processor 41 may be an integrated circuit chip with a signal processing capability. In an implementation process, each step of the method may be completed by an integrated logic circuit of hardware in the processor 41 or an instruction in a software form. The processor 41 may be a universal processor, a DSP or another Programmable Logic Device (PLD), a discrete gate or transistor logic device, a discrete hardware component and the like. The processor 41 may implement or execute each method, step and logical block diagram disclosed in the embodiments of the disclosure. The universal processor may be a microprocessor, any conventional processor or the like. The steps of the method disclosed in combination with the embodiment of the disclosure may be directly embodied to be executed and completed by a hardware decoding processor or executed and completed by a combination of hardware and software modules in the decoding processor. The software module may be located in a storage medium, and the storage medium is located in the memory 42. The processor 41 reads information in the memory 42 and completes the steps of the method in combination with hardware.

In an exemplary embodiment, the electronic device may be implemented by one or more Application Specific Integrated Circuits (ASICs), DSPs, PLDs, Complex Programmable Logic Devices (CPLDs), FPGAs, universal processors, controllers, MCUs, microprocessors or other electronic components, and is configured to execute the abovementioned method.

The embodiments of the disclosure also provide a computer-readable storage medium, in which a computer program may be stored, the program being executed by a processor to implement the steps of the method for detecting 3D human pose information of the embodiments of the disclosure.

The embodiments of the disclosure provide a method for detecting 3D human pose information, which may include that: first key points of a body of a target object in a first view image are obtained; second key points of the body of the target object in a second view image are obtained based on the first key point; and target 3D key points of the body of the target object are obtained based on the first key points and the second key points.

In some optional embodiments, the operation that the 3D key points are obtained based on the first key points and the second key points may include that: initial 3D key points are obtained based on the first key points and the second key points; and the initial 3D key points are regulated to obtain the target 3D key points.

In some optional embodiments, the operation that the initial 3D key points are regulated to obtain the target 3D key points may include that: a 3D projection range is determined based on the first key points and a preset camera calibration parameter; and for each of the initial 3D key points, a 3D key point of which a distance with the initial 3D key point meet a preset condition in the 3D projection range is obtained, and the 3D key point is determined as one of the target 3D key points.

In some optional embodiments, the 3D projection range may be a 3D range having a projection relationship with the first key points; and each of the 3D key points in the 3D projection range, after being projected to a plane where the first key points are located through the preset camera calibration parameter, may overlap one of the first key points on the plane where the first key points are located.

In some optional embodiments, the operation that the 3D key point of which the distance with the initial 3D key point meets the preset condition in the projection range is obtained may include that: multiple 3D key points in the 3D projection range are obtained according to a preset step; and for each of the 3D key points, an Euclidean distances between the 3D key point and the initial 3D key point is calculated, and a 3D key point corresponding to a minimum Euclidean distance is determined as one of the target 3D key points.

In some optional embodiments, the operation that the second key points of the body of the target object in the second view image are obtained based on the first key points may include that: the second key points of the body of the target object in the second view image are obtained based on the first key points and a pre-trained first network model; and the operation that the initial 3D key points are obtained based on the first key points and the second key points may include that: the initial 3D key points are obtained based on the first key points, the second key points and a pre-trained second network model.

In some optional embodiments, a training process of the first network model may include that: 2D key points of a second view are obtained based on sample 2D key points of a first view and a neural network; and a network parameter of the neural network is regulated based on labeled 2D key points and the 2D key points to obtain the first network model.

In some optional embodiments, a training process of the second network model may include that: 3D key points are obtained based on first sample 2D key points of the first view, second sample 2D key points of the second view and a neural network; and a network parameter of the neural network is regulated based on labeled 3D key points and the 3D key points to obtain the second network model.

The embodiments of the disclosure also provide an apparatus for detecting 3D human pose information, which may include an obtaining unit, a 2D information processing unit and a 3D information processing unit. The obtaining unit may be configured to obtain first key points of a body of a target object in a first view image.

The 2D information processing unit may be configured to obtain second key points of the body of the target object in a second view image based on the first key points obtained by the obtaining unit.

The 3D information processing unit may be configured to obtain target 3D key points of the body of the target object based on the first key points obtained by the obtaining unit and the second key points obtained by the 2D information processing unit.

In some optional embodiments, the 3D information processing unit may include a first processing module and a regulation module. The first processing module may be configured to obtain initial 3D key points based on the first key points and the second key points.

The regulation module may be configured to regulate the initial 3D key points obtained by the first processing module to obtain the target 3D key points.

In some optional embodiments, the regulation module may be configured to determine a 3D projection range based on the first key points and a preset camera calibration parameter, for each of the initial 3D key points, obtain a 3D key point of which a distance with the initial 3D key point meets a preset condition in the 3D projection range and determine the 3D key point as one of the target 3D key points.

In some optional embodiments, the 3D projection range may be a 3D range having a projection relationship with the first key points; and each of 3D key points in the 3D projection range, after being projected to a plane where the first key points are located through the preset camera calibration parameter, may overlap one of the first key points on the plane where the first key points are located.

In some optional embodiments, the regulation module may be configured to, for each of the initial 3D key points, obtain multiple 3D key points in the 3D projection range according to a preset step, calculate an Euclidean distance between each of the 3D key points and the initial 3D key point and determine a 3D key point corresponding to a minimum Euclidean distance as one of the target 3D key points.

In some optional embodiments, the 2D information processing unit may be configured to obtain the second key points based on the first key points and a pre-trained first network model.

The first processing module may be configured to obtain the initial 3D key points based on the first key points, the second key points and a pre-trained second network model.

In some optional embodiments, the apparatus may further include a first training unit, configured to obtain 2D key points of a second view based on sample 2D key points of a first view and a neural network, and regulate a network parameter of the neural network based on labeled 2D key points and the 2D key points to obtain the first network model.

In some optional embodiments, the apparatus may further include a second training unit, configured to obtain 3D key points based on first sample 2D key points of the first view, second sample 2D key points of the second view and a neural network, and regulate a network parameter of the neural network based on labeled 3D key points and the 3D key points to obtain the second network model.

The embodiments of the disclosure also provide a computer-readable storage medium, in which a computer program may be stored, the program being executed by a processor to implement the steps of the method of the embodiments of the disclosure.

The embodiments of the disclosure also provide an electronic device, which may include a memory, a processor and a computer program stored in the memory and capable of running in the processor, the processor executing the program to implement the steps of the method of the embodiments of the disclosure.

According to the method and apparatus for detecting 3D human pose information, electronic device and storage medium provided in the embodiments of the disclosure, the method includes that: the first key points of the body of the target object in the first view image are obtained; the second key points of the body of the target object in the second view image are obtained based on the first key points; and the target 3D key points of the body of the target object are obtained based on the first key points and the second key points. With adoption of the technical solutions of the embodiments of the disclosure, 2D key points of one view (or viewing angle) are obtained through 2D key points of another view (or viewing angle), and target 3D key points are obtained through the 2D key points of the two views (or viewing angles), so that the uncertainty of depth prediction is eliminated to a certain extent, the accuracy of the 3D key points is improved, and the accuracy of a network model is also improved.

The methods disclosed in some method embodiments provided in the application may be freely combined without conflicts to obtain new method embodiments.

The characteristics disclosed in some product embodiments provided in the application may be freely combined without conflicts to obtain new product embodiments.

The characteristics disclosed in some method or device embodiments provided in the application may be freely combined without conflicts to obtain new method embodiments or device embodiments.

In some embodiments provided by the application, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed.

In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a processing unit, each unit may also serve as an independent unit and two or more than two units may also be integrated into a unit. The integrated unit may be implemented in a hardware form and may also be implemented in form of hardware and software functional unit.

Those of ordinary skill in the art should know that all or part of the steps of the method embodiment may be implemented by related hardware instructed through a program, the program may be stored in a computer-readable storage medium, and the program is executed to execute the steps of the method embodiment. The storage medium includes: various media capable of storing program codes such as a mobile storage device, a ROM, a RAM, a magnetic disk or a compact disc.

Or, when being implemented in form of software functional module and sold or used as an independent product, the integrated unit of the disclosure may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a personal computer, a server, a network device or the like) to execute all or part of the method in each embodiment of the disclosure. The storage medium includes: various media capable of storing program codes such as a mobile hard disk, a ROM, a RAM, a magnetic disk or a compact disc.

The above is only the specific implementation of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for detecting three-dimensional (3D) human pose information, comprising:
obtaining first key points of a body of a target object in a first view image;
obtaining second key points of the body of the target object in a second view image based on the first key points; and
obtaining target 3D key points of the body of the target object based on the first key points and the second key points.

2. The method of claim 1, wherein obtaining the target 3D key points based on the first key points key points and the second key points key points comprises:
obtaining initial 3D key points based on the first key points and the second key points; and
regulating the initial 3D key points to obtain target 3D key points.

3. The method of claim 2, wherein regulating the initial 3D key points to obtain the target 3D key points comprises:
determining a 3D projection range based on the first key points and a preset camera calibration parameter; and
for each of the initial 3D key points,
obtaining a 3D key point of which a distance with the initial 3D key point meets a preset condition in the 3D projection range, and determining the 3D key points as one of the target 3D key points.

4. The method of claim 3, wherein the 3D projection range is a 3D range having a projection relationship with the first key points; and
each of the 3D key points in the 3D projection range, after being projected to a plane where the first key points are located through the preset camera calibration parameter, overlaps one of first key points on the plane where the first key points are located.

5. The method of claim 3, wherein obtaining the 3D key point of which the distance with the initial 3D key point meets the preset condition in the 3D projection range comprises:
obtaining multiple 3D key points in the 3D projection range according to a preset step; and
calculating a Euclidean distance between each of the 3D key points and the initial 3D key point, and determining the 3D key point corresponding to a minimum Euclidean distance as one of the target 3D key points.

6. The method of claim 4, wherein obtaining the 3D key point of which the distance with the initial 3D key point meets the preset condition in the 3D projection range comprises:
obtaining multiple 3D key points in the 3D projection range according to a preset step; and
calculating a Euclidean distance between each of the 3D key points and the initial 3D key point, and determining the 3D key point corresponding to a minimum Euclidean distance as one of the target 3D key points.

7. The method of claim 2, wherein obtaining the second key points of the body of the target object in the second view image based on the first key points comprises:
obtaining the second key points of the body of the target object in the second view image based on the first key points and a pre-trained first network model; and
wherein obtaining the initial 3D key points based on the first key points and the second key points comprises:
obtaining the initial 3D key points based on the first key points, the second key points and a pre-trained second network model.

8. The method of claim 3, wherein obtaining the second key points of the body of the target object in the second view image based on the first key points comprises:
obtaining the second key points of the body of the target object in the second view image based on the first key points and a pre-trained first network model; and
wherein obtaining the initial 3D key points based on the first key points and the second key points comprises:
obtaining the initial 3D key points based on the first key points, the second key points and a pre-trained second network model.

9. The method of claim 4, wherein obtaining the second key points of the body of the target object in the second view image based on the first key points comprises:
obtaining the second key points of the body of the target object in the second view image based on the first key points and a pre-trained first network model; and
wherein obtaining the initial 3D key points based on the first key points and the second key points comprises:
obtaining the initial 3D key points based on the first key points, the second key points and a pre-trained second network model.

10. The method of claim 7, wherein a training process of the first network model comprises:
obtaining two-dimensional (2D) key points of a second view based on sample 2D key points of a first view and a neural network; and
regulating a network parameter of the neural network based on labeled 2D key points and the 2D key points to obtain the first network model.

11. The method of claim 7, wherein a training process of the second network model comprises:
obtaining 3D key points based on first sample 2D key points of the first view, second sample 2D key points of the second view and a neural network; and
regulating a network parameter of the neural network based on labeled 3D key points and the 3D key points to obtain the second network model.

12. An electronic device, comprising a memory, a processor and a computer program stored in the memory and capable of running on the processor, the processor is configured to:
obtain first key points of a body of a target object in a first view image;
obtain second key points of the body of the target object in a second view image based on the first key points; and
obtain target 3D key points of the body of the target object based on the first key points and the second key points.

13. The electronic device of claim 12, wherein the processor is configured to:
obtain initial 3D key points based on the first key points and the second key points; and
regulate the initial 3D key points to obtain the target 3D key points.

14. The electronic device of claim 13, wherein the processor is configured to:
determine a 3D projection range based on the first key points and a preset camera calibration parameter, and
for each of the initial 3D key points, obtain a 3D key point of which a distance with the initial 3D key point meets a preset condition in the 3D projection range and determine the 3D key points as one of the target 3D key points.

15. The electronic device of claim 14, wherein the 3D projection range is a 3D range having a projection relationship with the first key points; and each of the 3D key points in the 3D projection range, after being projected to a plane where the first key points are located through the preset camera calibration parameter, overlaps one of the first key points on the plane where the first key points are located.

16. The electronic device of claim 14, wherein the processor is configured to, for each of the initial 3D key points, obtain multiple 3D key points in the 3D projection range according to a preset step, calculate a Euclidean distance between each of the 3D key points and the initial 3D key point and determine an 3D key point corresponding to a minimum Euclidean distance as one of the target 3D key points.

17. The electronic device of claim 13, wherein the processor is configured to obtain the second key points of the body of the target object in the second view image based on the first key points and a pre-trained first network model; and
the processor is configured to obtain the initial 3D key points based on the first key points, the second key points and a pre-trained second network model.

18. The electronic device of claim 17, wherein the processor is further configured to obtain 2D key points of a second view based on sample 2D key points of a first view and a neural network and regulate a network parameter of the neural network based on labeled 2D key points and the 2D key points to obtain the first network model.

19. The electronic device of claim 17, wherein the processor is further configured to obtain 3D key points based on first sample 2D key points of the first view, second sample 2D key points of the second view and a neural network and regulate a network parameter of the neural network based on labeled 3D key points and the 3D key points to obtain the second network model.

20. A non-transitory computer-readable storage medium, in which a computer program is stored, the program being executed by a processor to implement a method, comprising:
obtaining first key points of a body of a target object in a first view image;
obtaining second key points of the body of the target object in a second view image based on the first key points; and
obtaining target 3D key points of the body of the target object based on the first key points and the second key points.
